(19) United States
(12) Patent Application Publication
(10) Pub. No.: US 2003/0028652 A1
(43) Pub. Date: Feb. 6, 2003

(54) Apparatus for and method of invalidating or deleting digital content after it expires by comparing the embedded time with a global time

(75) Inventors: Richard A. Bardini, Los Gatos, CA (US); Glen Stone, Los Gatos, CA (US)

Correspondence Address: HAVERSTOCK & OWENS LLP, 162 NORTH WOLFE ROAD, SUNNYVALE, CA, 94086, US

(73) Assignee: Sony Corporation and Sony Electronics, Inc.

(21) Appl. No.: 09/920,660

(22) Filed: Aug. 1, 2001

(51) Int. Cl. H04N 7/16; G06F 15/16

(52) U.S. Cl. 709/229; 725/29

(57) ABSTRACT

A media storage device ensures that downloaded digital data is only accessible for a predetermined period of time. An expiration time and the requested digital data are encrypted and downloaded from a content provider and stored as encrypted data on the media storage device. The expiration time indicates a specific time at which the digital data will be made invalid. At the onset of a predetermined time interval, the media storage device obtains a current global time from a secure clock, decrypts the expiration time, and compares the current global time to the expiration time. If the expiration time is earlier than the current global time, then the digital data stored in the media storage device remains valid. While valid, the media storage device is able to retrieve and transmit the digital data for viewing. This process is repeated for each subsequent time interval. Once the expiration time elapses, the media storage device invalidates the digital data. Thereafter, the media storage device is unable to retrieve and transmit the digital data for viewing.

### FIELD OF THE INVENTION

The present invention relates to the field of invalidating or deleting digital content. More particularly, the present invention relates to the field of invalidating or deleting digital content after an expired time frame by comparing an embedded time with a global time.

### BACKGROUND OF THE INVENTION

Traditionally, people have been able to rent VHS videos and view the videos using a conventional VCR. Unfortunately, renting videos is often inconvenient, expensive if the video is not returned on time, and lacking in quality due to the nature of VHS tapes. CD-ROM technology, and more recently DVD technology, provides an increased level of video quality due to digitally stored content. With digital content comes improved quality, however the inconvenience and possible additional late fees associated with renting still exists.

Broadcast services provided by satellite and cable service providers continue to expand as users turn to the convenience of in-house services provided over these broadcast mediums. Pay-per-view movies can be ordered using a cable set-top box or satellite receiver and viewed on a televison. Unfortunately, pay-per-view movies are only available at predetermined times and users can not pause, rewind, or fast forward as desired.

As demand for digital content increases, so does the availability of mediums capable of transmitting the digital content. Cable service providers are offering digital cable, satellite service providers are offering digital satellite system (DSS), and television manufacturers are providing high definition television (HDTV). The internet has also provided a medium that enables users to receive audio and video content. Regardless of the transmission medium, the audio and video data streams representative of the digital content can be stored on conventional hard disk drive.

A traditional hard disk drive records data and plays it back according to commands received from an external controller using a protocol such as the serial bus protocol (SBP) or the audio/video control (AV/C) protocol. The external controller provides command data structures to the hard disk drive which inform the hard disk drive where on the media the data is to be written, in the case of a write application, or read from, in the case of a read operation.

Use of a media storage device, such as a hard disk drive, for storing streams of audio and video data is taught in U.S. patent application Ser. No. 09/022,926, filed on Feb. 12, 1998 and entitled “MEDIA STORAGE DEVICE WITH EMBEDDED DATA FILTER FOR DYNAMICALLY PROCESSING DATA DURING READ AND WRITE OPERATIONS,” which is hereby incorporated by reference.

Once received by the hard disk drive, the digital content can be displayed by any number of appropriately connected devices. The IEEE 1394-2000 serial bus provides one such connection.

The IEEE standard, “IEEE 1394-2000 Standard For A High Performance Serial Bus,” Draft ratified in 2000, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. The IEEE 1394-2000 standard bus architecture provides up to sixty-four (64) channels for isochronous data transfer between applications. A six bit channel number is broadcast with the data to ensure reception by the appropriate application. This allows multiple applications to simultaneously transmit isochronous data across the bus structure. Asynchronous transfers are traditional data transfer operations which take place as soon as possible and transfer an amount of data from a source to a destination.

The IEEE 1394-2000 standard provides a high-speed serial bus for interconnecting digital devices thereby providing a universal I/O connection. The IEEE 1394-2000 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394-2000 standard is very thin in size compared to other bulkier cables used to connect such devices. Devices can be added and removed from an IEEE 1394-2000 bus while the bus is active. If a device is so added or removed the bus will then automatically reconfigure itself for transmitting data between the then existing nodes. A node is considered a logical entity with a unique identification number on the bus structure. Each node provides an identification ROM, a standardized set of control registers and its own address space.

The IEEE 1394-2000 standard defines a protocol as illustrated in FIG. 1. This protocol includes a serial bus management block 10 coupled to a transaction layer 12, a link layer 14 and a physical layer 16. The physical layer 16 provides the electrical and mechanical connection between a device or application and the IEEE 1394-2000 cable. The physical layer 16 also provides arbitration to ensure that all devices coupled to the IEEE 1394-2000 bus have access to the bus as well as actual data transmission and reception. The link layer 14 provides data packet delivery service for both asynchronous and isochronous data packet transport. This supports both asynchronous data transport, using an acknowledgment protocol, and isochronous data transport, providing real-time guaranteed bandwidth protocol for just-in-time data delivery. The transaction layer 12 supports the commands necessary to complete asynchronous data transfers, including read, write and lock. The serial bus management block 10 contains an isochronous resource manager for managing isochronous data transfers. The serial bus management block 10 also provides overall configuration control of the serial bus in the form of optimizing arbitration timing, guarantee of adequate electrical power for all devices on the bus, assignment of the cycle master, assignment of isochronous channel and bandwidth resources and basic notification of errors.

The IEEE 1394-2000 cable environment is a network of nodes connected by point-to-point links, including a port on each node's physical connection and the cable between them. The physical topology for the cable environment of an IEEE 1394-2000 serial bus is a non-cyclic network of multiple ports, with finite branches. The primary restriction on the cable environment is that nodes must be connected together without forming any closed loops.

The IEEE 1394-2000 cable connects ports together on different nodes. Each port includes terminators, transceivers and simple logic. A node can have multiple ports at its physical connection. The cable and ports act as bus repeaters between the nodes to simulate a single logical bus.

### SUMMARY OF THE INVENTION

A media storage device ensures that downloaded digital data is only accessible for a predetermined period of time. An expiration time and the requested digital data are encrypted and downloaded from a content provider and stored on the media storage device. The expiration time indicates a specific time at which the digital data will be made invalid. The digital data is appropriately encrypted onto the media storage device as to only allow viewing and to prevent copying. At the onset of a predetermined time interval, the media storage device obtains a current global time from a secure clock, decrypts the expiration time, and compares the current global time to the expiration time. If the expiration time is earlier than the current global time, then the digital data stored in the media storage device remains valid. While valid, the media storage device is able to retrieve and transmit the digital data for viewing. This process is repeated for each subsequent time interval. Once the expiration time elapses, the media storage device invalidates the digital data. Thereafter, the media storage device is unable to retrieve and transmit the digital data for viewing.

Preferably, the media storage device is a stand-alone device within an IEEE 1394-2000 serial bus network, although the media storage device can alternatively be integrated into an appropriately configured computer or television. The media storage device preferably includes an interface circuit for receiving downloaded digital data, a media for storing the digital data, and a control circuit for comparing the current time to the expiration time and enabling the stored digital data to be read from the media if the expiration time is earlier than the current time and invalidating the stored digital data if the expiration time is later than or equal to the current time.

### BRIEF DESCRIPTION OF THE DRAWINGS

FIG. 1 illustrates a protocol defined by the IEEE 1394-2000 standard.

FIG. 2 illustrates an exemplary IEEE 1394-2000 serial bus network of devices including a video camera, a video cassette recorder, a set-top box, a television, a computer and an audio/video hard disk drive of the present invention.

FIG. 3 illustrates an exemplary block diagram of the internal components of the computer 20.

FIG. 4 illustrates an exemplary block diagram of the internal components of the television 24.

FIG. 5 illustrates a block diagram of a media storage device according to the preferred embodiment of the present invention.

FIG. 6 illustrates a flowchart showing the preferred process of invalidating or deleting digital content according to the present invention.

### DETAILED DESCRIPTION OF THE PREFERRED EMBODIMENT

A communication link is established between a media storage device of the present invention and a remote content provider for completing a transaction and consequently downloading digital data from the content provider to the media storage device. After the transaction has been initiated, the content provider transmits an encrypted expiration time for the digital data that is to be downloaded. The expiration time indicates a specific time at which the digital data will be made invalid. The digital data is then downloaded and stored on the media storage device. The digital data is appropriately encrypted onto the media storage device as to only allow viewing and to prevent copying. At the onset of a predetermined time interval, the media storage device obtains a current global time from a secure clock, decrypts the expiration time, and compares the current global time to the expiration time. If the expiration time is earlier than the current global time, then the digital data stored in the media storage device remains valid. While valid, the media storage device is able to retrieve and transmit the digital data for viewing. This process is repeated for each subsequent time interval. Once the expiration time elapses, the media storage device invalidates the digital data. Thereafter, the media storage device is unable to retrieve and transmit the digital data for viewing.

Preferably, the media storage device is a stand-alone device within a network of devices. Alternatively, the media storage device is included within another device, for example a televison or a computer. The network of devices preferably form an IEEE 1394-2000 serial bus network wherein one of the devices within the IEEE 1394-2000 serial bus network is properly configured to receive data from a remote source over a conventional network, for example the internet. The downloaded digital data is preferably received by the properly configured network device and transmitted from the network device to the media storage device on an isochronous channel over the IEEE 1394-2000 serial bus network. The isochronous channel is set-up in the conventional manner using techniques well known in the art of IEEE 1394-2000 serial bus networks.

Preferably, the transaction is initiated between the content provider and the media storage device by a user through a graphical user interface (GUI). The GUI is of any conventional type, for example on a computer with keyboard and mouse or on a television with remote control device. Preferably, the GUI resides on one of the network devices within the IEEE 1394-2000 serial bus network that includes the media storage device. It should be clear to those skilled in the art that other means can be used by a user to initiate a transaction with the content provider, for example the user can place a conventional telephone call to the content provider specifying the media storage device to which the desired digital data is to be downloaded.

When downloading the digital data, the digital data is preferably encrypted for copy protection. When the media storage device receives the encrypted digital data, the data is encrypted onto the media storage device using conventional encryption techniques that may or may not be the same as the encryption techniques used on the digital data when downloaded from the content provider to the media storage device. Encryption of the digital data onto the media storage device prevents unauthorized use. Even if the digital data is accessed while on the media storage device, the digital data still needs to be decrypted for use. To view the encrypted digital data stored on the media storage device, conventional authentication techniques are performed.

The media storage device preferably includes an audio/video (AV) hard disk drive for storing the digital data. Alternatively, any appropriate media storage device such as DVD-RW or flash memory can be utilized. Additionally, the media storage device preferably includes a controller for controlling all aforementioned processes performed by the media storage device. The controller is preferably integrated within the AV hard disk drive, or whatever storage media is used. Alternatively, the controller resides external to the media storage device and sends control signals over the IEEE 1394-2000 serial bus network to the media storage device. Preferably, the media storage device includes an isochronous data pipe which controls data storage and retrieval operations, as will be discussed below. Preferably, the media storage device accepts control instructions directly from other devices within the IEEE 1394-2000 serial bus network. Alternatively, a separate control device within the IEEE 1394-2000 serial bus network is utilized to provide a control interface between the media storage device and the other devices within the network.

When the digital data is to be viewed, the digital data is preferably transmitted over an IEEE 1394-2000 serial bus network connection between the media storage device and a display. The digital data transmitted from the media storage device to the display is preferably encrypted using any appropriate manner of encryption. Alternatively, digital data transmitted between the media storage device and the display is not encrypted.

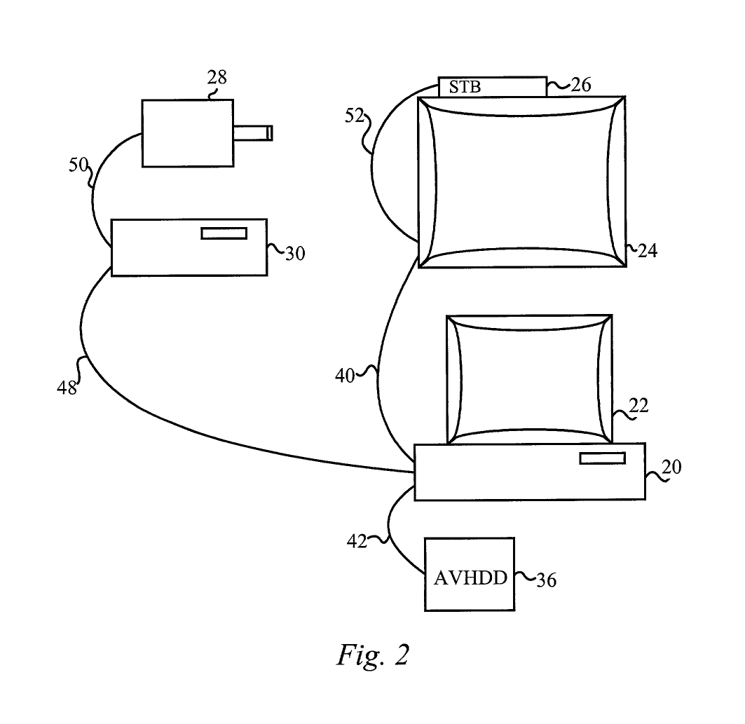

FIG. 2 illustrates an exemplary network of devices including a video camera 28, a video cassette recorder (VCR) 30, a settop box 26, a television 24, a computer 20 and an audio/video hard disk drive (AVHDD) 36 coupled together by IEEE 1394-2000 cables 40, 42, 48, 50 and 52. The IEEE 1394-2000 cable 50 couples the video camera 28 to the VCR 30, allowing the video camera 28 to send data, commands and parameters to the VCR 30 for recording. The IEEE 1394-2000 cable 48 couples the VCR 30 to the computer 20. The IEEE 1394-2000 cable 42 couples the computer 20 to the AVHDD 36. The IEEE 1394-2000 cable 40 couples the computer 20 to the television 24. The IEEE 1394-2000 cable 52 couples the television 24 to the settop box 26.

The configuration illustrated in FIG. 2 is exemplary only. It should be apparent that an audio/video network could include many different combinations of components. The devices within such an IEEE 1394-2000 network are autonomous devices, meaning that in an IEEE 1394-2000 network, as the one illustrated in FIG. 2, in which a computer is one of the devices, there is not a true “master-slave” relationship between the computer and the other devices. In many IEEE 1394-2000 network configurations, a computer may not be present. Even in such configurations, the devices within the network are fully capable of interacting with each other on a peer basis. It should be recognized that data, commands and parameters can be sent between all of the devices within the IEEE 1394-2000 network, as appropriate.

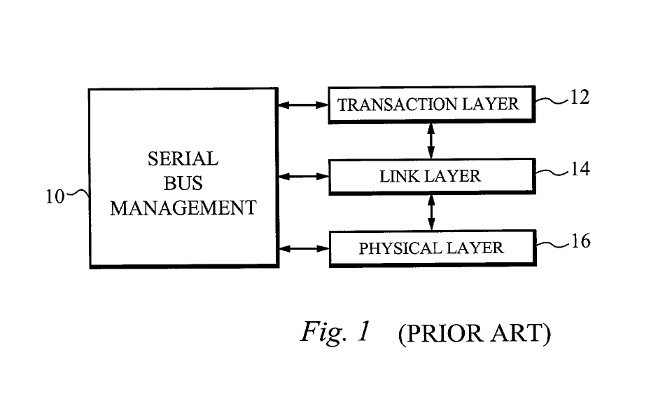

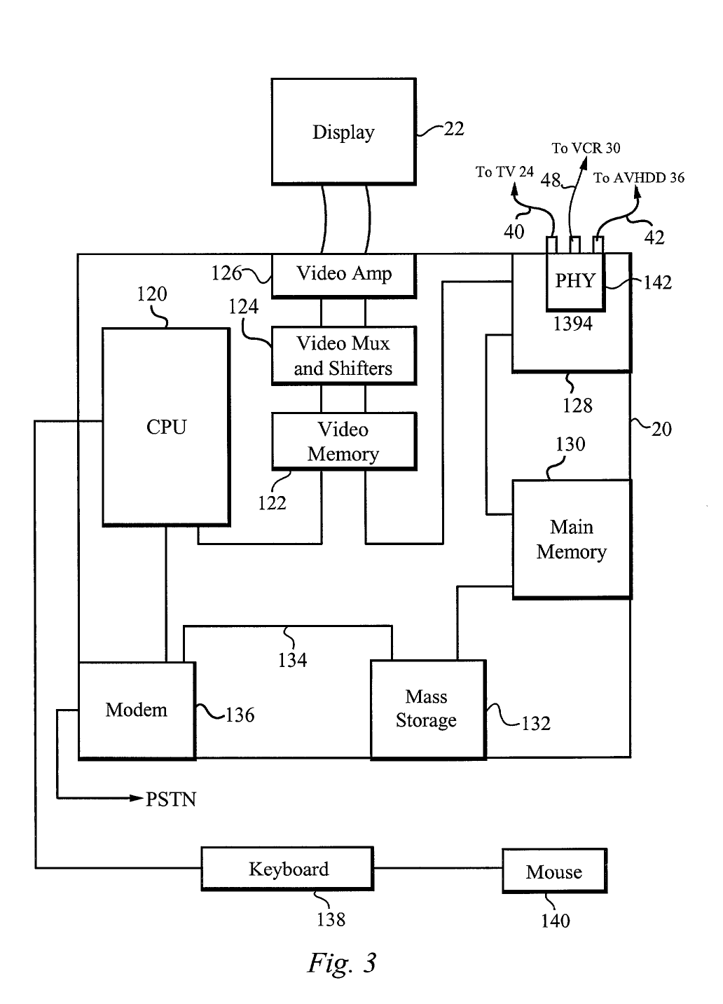

A block diagram of the internal components of the computer system 20 is illustrated in FIG. 3. Within the drawings, the same elements as to FIGS. 1-6 are labeled with the same numbers. The computer system 20 includes a central processor unit (CPU) 120, a main memory 130, a video memory 122, a mass storage device 132, a modem 136, and an IEEE 1394-2000 interface circuit 128, all coupled together by a conventional bidirectional system bus 134. The modem 136 is preferably coupled to the public switched telephone network (PSTN) for sending and receiving communications. The interface circuit 128 includes the physical interface circuit 142 for sending and receiving communications on the IEEE 1394-2000 serial bus network. The physical interface circuit 142 is coupled to the television 24, to the VCR 30, and to the AVHDD 36 over the IEEE 1394-2000 serial bus cables 40, 48, and 42, respectively. In the preferred embodiment of the present invention, the interface circuit 128 is implemented on an IEEE 1394-2000 interface card within the computer system 20. However, it should be apparent to those skilled in the art that the interface circuit 128 can be implemented within the computer system 20 in any other appropriate manner, including building the interface circuit onto the motherboard itself. The mass storage device 132 may include both fixed and removable media using any one or more of magnetic, optical or magneto-optical storage technology or any other available mass storage technology. The system bus 134 contains an address bus for addressing any portion of the memory 122 and 130. The system bus 134 also includes a data bus for transferring data between and among the CPU 120, the main memory 130, the video memory 122, the mass storage device 132, the modem 136, and the interface circuit 128.

The computer system 20 is also coupled to a number of peripheral input and output devices including the keyboard 138, the mouse 140 and the associated display 22. The keyboard 138 is coupled to the CPU 120 for allowing a user to input data and control commands into the computer system 20. A conventional mouse 140 is coupled to the keyboard 138 for manipulating graphic images on the display 22 as a cursor control device. As discussed above, a user can utilize the computer system 20 to initiate a transaction with a content provider.

A port of the video memory 122 is coupled to a video multiplex and shifter circuit 124, which in turn is coupled to a video amplifier 126. The video amplifier 126 drives the display 22. The video multiplex and shifter circuitry 124 and the video amplifier 126 convert pixel data stored in the video memory 122 to raster signals suitable for use by the display 22.

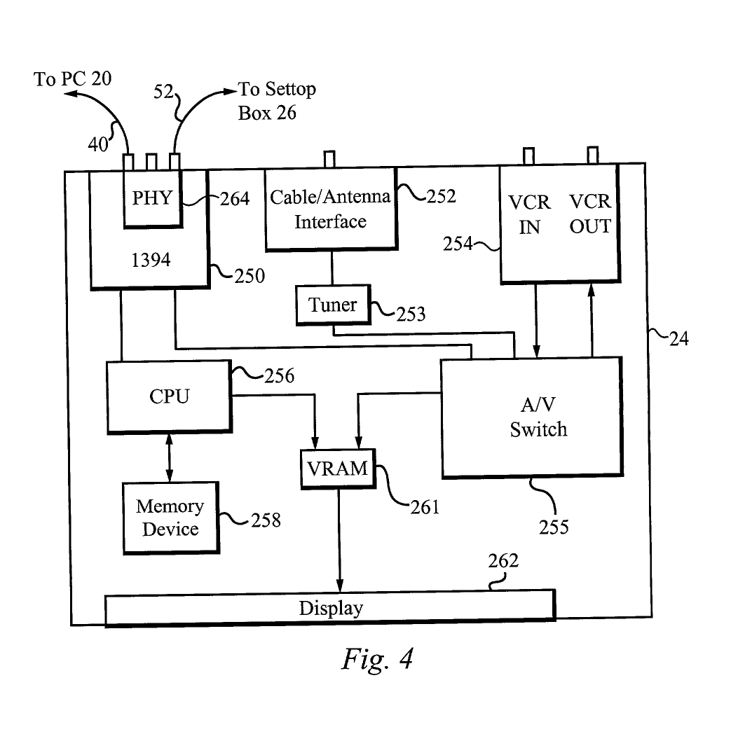

A block diagram of the internal components within the television 24 is illustrated in FIG. 4. An IEEE 1394-2000 interface circuit 250 includes a physical interface circuit 264. The physical interface circuit 264 is coupled to the PC 20 and to the set top box 26, over the IEEE 1394-2000 serial bus cables 40 and 52, respectively. The IEEE 1394-2000 interface circuit 250 is coupled to a CPU 256 for controlling communications between the CPU 256 and devices coupled to the IEEE 1394-2000 serial bus network. The IEEE 1394-2000 interface circuit 250 is also coupled to an audio/video switch 255 for providing video signals from the devices coupled to the IEEE 1394-2000 serial bus network. A cable/antenna interface circuit 252 is coupled to receive input signals from a coaxial cable or an antenna and to pass those signals through a tuner 253 to the audio/video switch 255. A traditional VCR interface circuit 254 is coupled to receive input signals from and send output signals to conventional VCR(s). The VCR interface circuit 254 is also coupled to the audio/video switch 255 for directing audio/video signals to and from the VCR(s).

A memory device 258 is coupled to the CPU 256 for storing information. The audio/video switch 255 and the CPU 256 are coupled to the video random access memory (VRAM) circuit 261 for providing video input signals to the VRAM circuit 261 from the multiple sources. The VRAM circuit 261 provides the video signals to the display 262. If a compressed video stream of data is received by the television 24, that stream of data is decompressed before being sent to the VRAM circuit 261 by a coder/decoder circuit (CODEC) or other appropriate decompression engine, within the television 24.

As discussed above, a user can utilize the television 24 to initiate a transaction with a content provider. As related to the IEEE 1394-2000 serial bus network of devices in FIG. 2, either the computer system 20 or the television 24 can be coupled to a conventional network, such as the internet, to provide a communication path between the content provider and the network of devices. The network device that initiates the transaction and the network device that provides the communication path need not be the same device. Regardless of which network device provides the communication path with the content provider, an appropriately configured isochronous channel is established over the IEEE 1394-2000 serial bus network between the network device providing the communication path with the content provider and the AVHDD 36, thereby forming a communication path between the content provider and the AVHDD 36. The communication path between the content provider and the AVHDD 36 enables the encrypted expiration time, the encrypted digital data, and the keys to decrypting them both, to be downloaded to and stored by the AVHDD 36.

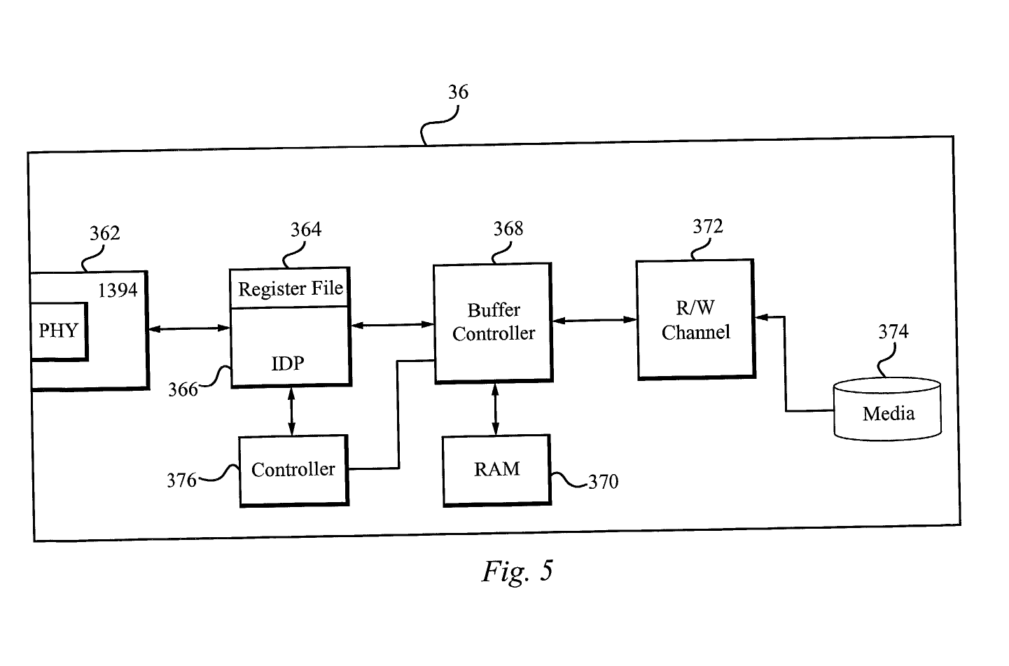

FIG. 5 illustrates a block diagram of the preferred embodiment of a hardware system resident in the AVHDD 36. The AVHDD 36 includes an IEEE 1394-2000 serial bus interface circuit 362 for sending communications to and receiving communications from other network devices coupled to the IEEE 1394-2000 serial bus network. The interface circuit 362 is coupled to an embedded filter 366. Preferably, the embedded filter 366 is an isochronous data pipe, as will be discussed below. The embedded filter 366 is coupled to a buffer controller 368. The buffer controller 368 is also coupled to a RAM 370 and to a read/write channel circuit 372. The read/write channel circuit 372 is coupled to media 374 on which data is stored within the AVHDD 36. The read/write channel circuit 372 controls the storage operations on the media 374, including reading data from the media 374 and writing data to the media 374. A controller 376 is coupled to the embedded filter 366 for controlling the manipulation of data streams and to the buffer controller 368 for controlling read and write operations to the media 374.

During a write operation to the AVHDD 36, the IEEE 1394-2000 serial bus interface circuit 362 receives a stream of data from the IEEE 1394-2000 serial bus. The interface circuit 362 then forwards this data to the embedded filter 366. The embedded filter 366 modifies the data as specified by the programmed instructions from the controller 376, and forwards the modified data to the buffer controller 368. Data modification includes, but is not limited to, decryption, encryption, and reformatting. The buffer controller 368 then stores this modified data temporarily in a buffer in the RAM 370. When the read/write channel circuit 372 is available, the buffer controller 368 reads the data from the RAM 370 and forwards it to the read/write channel circuit 372. The read/write channel circuit 372 then writes the data onto the media 374. Because the embedded filter 366 is programmable, the data can be manipulated during a write operation, during a read operation or during both write and read operations.

During a read operation from the AVHDD 36, a stream of data is read from the media 374 by the read/write channel circuit 372. The read operation is only performed after the controller 376 determines that the data to be read is still valid. This validation process will be discussed in greater detail below. This stream of data is forwarded by the read/write channel circuit 372 to the buffer controller 368. The buffer controller 368 then stores this data temporarily in a circular buffer in the RAM 370. When the IEEE 1394-2000 serial bus interface circuit 362 is available, the buffer controller 368 reads the data from the RAM 370 and forwards it to the embedded filter 366. If the embedded filter 366 is programmed to manipulate the data stream during a read operation, this manipulation is performed and the data is forwarded to the IEEE 1394-2000 serial bus interface circuit 362. The IEEE 1394-2000 serial bus interface circuit 362 then formats the data according to the requirements of the IEEE 1394-2000 standard and transmits this data to the appropriate device or devices over the IEEE 1394-2000 serial bus.

The embedded filter 366 is preferably programmed by the controller 376 to manipulate streams of data received by or to be transmitted by the AVHDD 36. Alternatively, the embedded filter 366 includes fixed firmware for performing the appropriate manipulations. The embedded filter 366 can be programmed to manipulate streams of data on the way into the media storage device and on the way out of the media storage device. As an example of the utilization of the embedded filter 366 within an IEEE 1394-2000 serial bus network, streams of data being written to the media storage device from any device on the network can all be formatted into a first format when they are stored on the media 374. Then when data is read from the media 374 for transmission to a particular device, that data can be manipulated by the embedded filter 366 into an appropriate format for the particular device.

As described above, the embedded filter 366 is preferably an isochronous data pipe. A preferred embodiment of the isochronous data pipe 366 is taught in U.S. patent application Ser. No. 08/612,322, filed on Mar. 7, 1996 and entitled “ISOCHRONOUS DATA PIPE FOR MANAGING AND MANIPULATING A HIGH-SPEED STREAM OF ISOCHRONOUS DATA FLOWING BETWEEN AN APPLICATION AND A BUS STRUCTURE,” which is hereby incorporated by reference. The isochronous data pipe 366 is programmable and will execute a series of instructions on a stream of data in order to perform manipulations on the data as required for decrypting, encrypting, and appropriate formatting. The isochronous data pipe 366 can be programmed to manipulate both asynchronous and isochronous data. A register file 364 is programmed by the controller 376 and used to manipulate the data flowing through the isochronous data pipe 366, as necessary.

A transaction between a user and a content provider is initiated by a user using a computer, a television, a telephone, or any other conventional means for establishing a communications link. Based upon the transaction, the content provider is to provide specified content to a designated media storage device where the content is able to be accessed until a predetermined time. A communication path is established between the content provider and the media storage device which is to receive the content. The content to be provided by the content provider and the expiration time at which the content will become invalid is encrypted and transmitted, along with the key(s) to decrypting them both, to the media storage device over the established communication path. The media storage device cyclically performs the process of determining if the transmitted content remains valid.

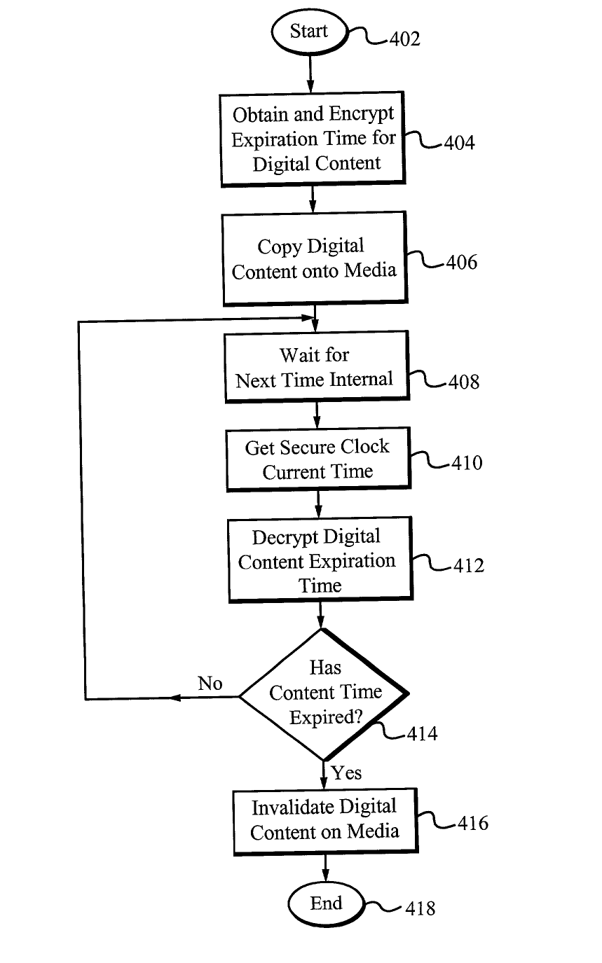

A flowchart showing the preferred process of invalidating or deleting digital content according to the present invention is illustrated in FIG. 6. The process begins at the step 402. At the step 404, the content provider obtains and encrypts an appropriate expiration time for the digital content to be downloaded. Any conventional manner of encryption is sufficient. The encrypted expiration time is downloaded to the AVHDD 36. The appropriate expiration time results from the nature of the transaction between the user and the content provider.

At the step 406, the desired digital content is downloaded and stored on the AVHDD 36. Specifically, the digital content is stored on the media 374 within the AVHDD 36. The encrypted expiration time and the encrypted digital content are transmitted over the communication path established between the AVHDD 36 and the content provider as discussed above. The process of storing the encrypted digital content is the same as discussed above in regards to the AVHDD 36 of FIG. 5. At the step 408, the AVHDD 36 waits for the next time interval, as determined by a clock within the controller 376. Preferably, each time interval is one minute in length although any measure of time including seconds, minutes, hours, days, weeks, months, or years is appropriate. Once the current time interval has elapsed, at the step 410 the current time is obtained from a secure clock. The secure clock is provided by any conventional means that is coupled to the AVHDD 36 or to the network on which the AVHDD 36 resides. The secure clock is different than a local clock, for example a PC-based clock. With a local clock, the user can locally alter the time. Providing means for the user to alter the current time is not desirable. A preferred method of obtaining a current time from a secure clock is taught in U.S. patent application Ser. No. ______, filed on ______, and entitled “______”, which is hereby incorporated by reference. At the step 412, the encrypted expiration time of the downloaded digital content is decrypted. At the step 414, it is determined if the expiration time is equal to or greater than the current time. If the expiration time is not equal to or greater than the current time, then the digital content remains valid and the process jumps back to the step 408. If it is determined at the step 414 that the expiration time is equal to or greater than the current time, then the process moves to the step 416. At the step 416, the downloaded digital content is invalidated on the media 374. It should be noted that the digital data can also be deleted from the media 374 although most conventional hard disk drives do not actually erase data. Instead, hard disk drives disable their ability to access the data, thereby invalidating the data. In which case, the invalidated data physically remains on the hard disk drive until it is written over. The process then ends at the step 418.

The AVHDD 36 also includes a power-up condition. When the AVHDD 36 is powered on, the step 410, and all subsequent steps, are performed automatically to determine the validity of the stored digital content without waiting for the next appropriate time interval.

An alternative embodiment of the present invention allows downloaded digital content that has been invalidated by the AVHDD 36 to be re-validated. Re-validating content that already exists within the AVHDD 36 eliminates the need to have to again download the content from the content provider. Only invalid data that has not been written over is capable of being re-validated. A new encrypted expiration time is required for the invalid content to be re-validated. The new encrypted expiration time is provided to the AVHDD 36 in the same manner as the original encrypted expiration time was provided, as discussed above.

Similarly, an additional key can be provided that extends the expiration time or eliminates the expiration time altogether before the digital data is invalidated.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is used with an IEEE 1394-2000 serial bus structure, the present invention could also be implemented on any other appropriate bus structures or network connections.

I claim:

1. A method of invalidating stored data after a predetermined period of time comprising:
a. obtaining a current time from a clock source;
b. decrypting an expiration time associated with the stored data;
c. comparing the expiration time to the current time; and
d. invalidating the stored data if the current time is earlier than or equal to the expiration time.

2. The method according to claim 1 wherein a-c are performed once every predetermined time interval until the current time is later than or equal to the expiration time.

3. The method according to claim 1 wherein the expiration time is received as an encrypted expiration time from a remote source.

4. The method according to claim 3 wherein stored data is downloaded from the remote source as encrypted data.

5. The method according to claim 1 wherein the stored data is stored on a media storage device, further wherein the media storage device is a stand-alone device within an IEEE 1394-2000 serial bus network.

6. The method according to claim 1 wherein the stored data is stored on a media storage device integrated within a television.

7. The method according to claim 1 wherein the stored data is stored on a media storage device integrated within a computer.

8. The method according to claim 1 further comprising re-validating the invalidated stored data by obtaining a new expiration time associated with the invalidated data.

9. The method according to claim 1 wherein the expiration time is extended by obtaining an extended expiration time before the stored data is invalidated and further wherein the extended expiration time replaces the expiration time.

10. The method according to claim 1 wherein the clock source is a secure clock source.

11. A media storage device for invalidating stored data after a predetermined period of time, the media storage device comprising:
a. an interface circuit for receiving a stream of data, wherein the stream of data includes content and an expiration time associated with the content;
b. a media coupled to the interface circuit for storing the received stream of data; and
c. a control circuit coupled to the interface circuit and the media for comparing a current time to the expiration time and enabling the stored content to be read from the media if the expiration time is earlier than the current time and invalidating the received stream of data if the expiration time is later than or equal to the current time.

12. The media storage device according to claim 11 wherein the control circuit compares the current time to the expiration time once every predetermined time interval until the expiration time elapses.

13. The media storage device according to claim 11 wherein the media storage device is a stand-alone device within a 1394-2000 serial bus network.

14. The media storage device according to claim 13 wherein when the stored content is read from the media, the stored content is transmitted from the media storage device over the IEEE 1394-2000 serial bus to a display device.

15. The media storage device according to claim 14 wherein the transmitted data is encrypted.

16. The media storage device according to claim 11 further comprising a manipulating circuit coupled to the control circuit for encrypting and decrypting the stream of data received by and transmitted from the media storage device.

17. The media storage device according to claim 11 wherein the media storage device is integrated within a television.

18. The media storage device according to claim 11 wherein the media storage device is integrated within a computer.

19. The media storage device according to claim 11 wherein the clock source is a secure clock source.

20. The media storage device according to claim 11 wherein the content is viewable content.

21. A method of reading stored data from a media storage device comprising:
a. decrypting an expiration time stored within the media storage device, wherein the expiration time is associated with the stored data to be read;
b. comparing the expiration time to a global time to determine if the expiration time has elapsed; and
c. reading the stored data from the media storage device if the expiration time has not elapsed.

22. The method according to claim 21 wherein a-b are performed once every predetermined time interval until the expiration time has elapsed.

23. The method according to claim 22 wherein reading the stored data continues until the expiration time has elapsed, at which time the stored data is invalidated and reading the stored data discontinues.

24. The method according to claim 21 wherein the media storage device is a stand-alone device within an IEEE 1394-2000 serial bus network.

25. The method according to claim 24 wherein the stored data is transmitted from the media storage device over the IEEE 1394-2000 serial bus to a display device.

26. The method according to claim 25 wherein the transmitted data is encrypted.

27. The method according to claim 21 wherein the expiration time is received as an encrypted expiration time from a remote source.

28. The method according to claim 27 wherein stored data is downloaded from the remote source as encrypted data.

29. The method according to claim 21 wherein the stored data is stored on a media storage device integrated within a television.

30. The method according to claim 21 wherein the stored data is stored on a media storage device integrated within a computer.

31. The method according to claim 21 wherein the expiration time is extended by obtaining an extended expiration time before the stored data is invalidated, wherein the extended expiration time replaces the expiration time.

32. The method according to claim 21 wherein the global time is obtained from a secure source.

33. A media storage device for storing data and invalidating stored data after a predetermined period of time, the media storage device comprising:
a. means for obtaining a current time from a clock source;
b. means for decrypting an expiration time associated with the stored data;
c. means for comparing the expiration time to the current time; and
d. means for invalidating the stored data if the current time is earlier than or equal to the expiration time.

34. The media storage device according to claim 33 wherein the means for comparing compares the expiration time to the current time once every predetermined time interval until the expiration time elapses.

35. The media storage device according to claim 33 wherein the media storage device is a stand-alone device within a 1394-2000 serial bus network.

36. The media storage device according to claim 33 further comprising means for reading stored content from the media storage device.

37. The media storage device according to claim 36 wherein when the stored content is read from the media, the stored content is transmitted from the media storage device over the IEEE 1394-2000 serial bus to a display device.

38. The media storage device according to claim 37 wherein the transmitted data is encrypted.

39. The media storage device according to claim 33 wherein the expiration time is received as an encrypted expiration time from a remote source.

40. The media storage device according to claim 39 wherein stored data is downloaded from the remote source as encrypted data.

41. The media storage device according to claim 33 wherein the stored data is stored on a media storage device integrated within a television.

42. The media storage device according to claim 33 wherein the stored data is stored on a media storage device integrated within a computer.

43. The media storage device according to claim 33 wherein the clock source is a secure clock source.

44. A method of invalidating stored data after a predetermined time period comprising:
a. waiting until a predetermined time interval has elapsed;
b. obtaining a global time from a clock source;
c. decrypting an expiration time associated with the downloaded data;
d. comparing the expiration time to the global time to determine if the expiration time has elapsed;
e. repeating a-d until the expiration time has elapsed; and
f. invalidating the stored data when the expiration time has elapsed.

45. The method according to claim 44 wherein the expiration time is received as an encrypted expiration time from a remote source.

46. The method according to claim 45 wherein stored data is downloaded from the remote source as encrypted data.

47. The method according to claim 44 wherein the stored data is stored on a media storage device, wherein the media storage device is a stand-alone device within an IEEE 1394-2000 serial bus network.

48. The method according to claim 44 wherein the stored data is stored on a media storage device integrated within a television.

49. The method according to claim 44 wherein the stored data is stored on a media storage device integrated within a computer.

50. The method according to claim 44 further comprising re-validating the invalidated stored data by obtaining a new expiration time associated with the invalidated data.

51. The method according to claim 44 wherein the expiration time is extended by obtaining an extended expiration time before the stored data is invalidated, wherein the extended expiration time replaces the expiration time.

52. The method according to claim 44 wherein the clock source is a secure clock source.

53. A method of invalidating stored data after a predetermined time period comprising:
a. obtaining an encrypted expiration time from a remote source;
b. downloading an encrypted data stream associated with the expiration time onto a media storage device;
c. waiting until a predetermined time interval has elapsed;
d. obtaining a global time from a clock source;
e. decrypting the expiration time associated with the downloaded data;
f. comparing the expiration time to the global time to determine if the expiration time has elapsed;
g. repeating c-f until the expiration time has elapsed; and
h. invalidating the stored data when the expiration time has elapsed.

54. The method according to claim 53 wherein the clock source is a secure clock source.

55. A network of devices comprising:
a. a receiving device for obtaining a received stream of data; and
b. a media storage device coupled to the receiving device for storing the received stream of data and invalidating the stored stream of data after a predetermined period of time, the media storage device comprising:
i. an interface circuit for receiving the received stream of data from the receiving device, wherein the stream of data includes content and an expiration time associated with the content;
ii. a media coupled to the interface circuit for storing the received stream of data; and
iii. a control circuit coupled to the interface circuit and the media for comparing a current time to the expiration time and enabling the stored content to be read from the media if the expiration time is earlier than the current time and invalidating the received stream of data if the expiration time is later than or equal to the current time.

56. The network of devices according to claim 55 wherein the control circuit compares the current time to the expiration time once every predetermined time interval until the expiration time elapses.

57. The network of devices according to claim 55 wherein the media storage device is a stand-alone device within an IEEE 1394-2000 serial bus network.

58. The network of devices according to claim 57 wherein when the stored content is read from the media, the stored content is transmitted from the media storage device over the IEEE 1394-2000 serial bus to a display device.

59. The network of devices according to claim 58 wherein the transmitted data is encrypted.

60. The network of devices according to claim 55 further comprising a manipulating circuit coupled to the control circuit for encrypting and decrypting the stream of data received by and transmitted from the media storage device.

61. The network of devices according to claim 55 wherein the media storage device is integrated within a television.

62. The network of devices according to claim 55 wherein the media storage device is integrated within a computer.

63. The network of devices according to claim 55 wherein the current time is obtained from a secure source.

64. The network of devices according to claim 55 wherein the content is viewable content.
